(19) United States
(12) Patent Application Publication
(10) Pub. No.: US 2010/0168348 A1
(43) Pub. Date: Jul. 1, 2010

(54) ANIONIC SPRAY POLYMERIZATION OF STYRENE

(75) Inventors: Wolfgang Loth, Bad Durkheim (DE); Volker Seidl, Mannheim (DE); Stefan Bruhns, Mannheim (DE); Klaus-Dieter Hungenberg, Birkenau (DE); Juergen Koch, Neuhofen (DE); Christian Schade, Ludwigshafen (DE); Claudius Schwittay, Heidelberg (DE)

Correspondence Address: CONNOLLY BOVE LODGE & HUTZ LLP, 1875 EYE STREET, N.W., SUITE 1100, WASHINGTON, DC, 20006, US

(73) Assignee: BASF AKTIENGESELLSCHAFT, Ludwigshafen (DE)

(21) Appl. No.: 12/063,166

(22) PCT Filed: Aug. 1, 2006
(86) PCT No.: PCT/EP06/64924

§ 371 Date: Feb. 7, 2008

(30) Foreign Application Priority Data
Aug. 9, 2005 (DE) 10 2005 038 037.9

(51) Int. Cl. C08L 25/06; C08F 2/00

(52) U.S. Cl. 526/88

(57) ABSTRACT

The invention relates to a process for continuously preparing styrene polymers by anionic spray polymerization, which comprises
i) styrene and the initiator solution being mixed in a dynamic or static mixer and then the mixture being sprayed,
ii) the resultant droplets passing from the liquid monomer state to the melted polymer state during their free fall in the spraying tower,
iii) the melt droplets being collected as a melt at the foot of the tower, the melt having a monomer content of below 1%, preferably below 0.1% (<1000 ppm), and being discharged by suitable means.

The invention relates to a process for continuously preparing styrene polymers by anionic spray polymerization, which comprises
i) styrene and the initiator solution being mixed in a dynamic or static mixer and then the mixture being sprayed,
ii) the resultant droplets passing from the liquid monomer state to the melted polymer state during their free fall in the spraying tower,
iii) the melt droplets being collected as a melt at the foot of the tower, the melt having a monomer content of below 1%, preferably below 0.1% (<1000 ppm), and being discharged by suitable means.

The anionic polymerization of styrene is a highly exothermic reaction and is therefore mostly carried out in solution in a low boiler which by virtue of the cold of evaporation absorbs the heat of polymerization. In the majority of anionic processes for styrene (co)polymers the polymers are obtained as a solution in a solvent (U.S. Pat. No. 4,442,273; U.S. Pat. No. 4,883,846, U.S. Pat. No. 5,902,865) and must be freed via appropriate degassing means from the solvent and, optionally, from low molecular mass impurities, such as monomers and oligomers, and converted to a solid.

In the polymerization of styrene alone at low temperature, as described in DE 1 139 975, the polymers are obtained as a solid. Another process starting from monomer, initiator, and optional solvent, which likewise ends in the solid, is described in U.S. Pat. No. 5,269,980.

Anionic spray polymerizations of 1,3-butadiene are described in the literature, where the polymer formed is captured in a hydrocarbon countercurrent (U.S. Pat. No. 3,350,377) or in a styrene solution (DE 199 04 058), and where a dispersion or solution is generated and the polymerization is terminated at the same time.

Anionic polymerization of styrene in bulk, viz. without solvent, is described in U.S. Pat. No. 5,587,438. The temperature in the spraying tower is regulated by an inert gas counter-current, so that polymerization in the droplets, which measure 0.5 to 3 mm, takes place at temperatures below 100° C. The resulting polystyrene is therefore obtained as a solid.

US 2003/0073792 describes a batch process for anionic polymerization of styrene. The reaction is carried out adiabatically. In order to intercept the considerable heat given off, solid polystyrene is added to the reaction event.

As remarked above, the prior art has disclosed the anionic polymerization of styrene with an isothermal reaction regime below 100° C. This procedure leads to solid polystyrene having a relatively high residual monomer content. Prior to further processing the polystyrene must usually be melted and degassed. An alternative is polymerization in solution, which leads to considerable cost and complexity as regards subsequent solvent removal and product workup. In both cases, moreover, the low reaction temperatures lead to low space-time yields and high residence times, which make the process economically unattractive.

Alternatively, in order to realize an adiabatic procedure as in US 2003/0073792, the reaction mixture must be diluted with previously formed polystyrene, which again leads to low space-time yields and therefore is uneconomic.

It was an object of the present invention, accordingly, to find a process from which the above disadvantages are absent. The intention in particular was to find a process which with high space/time yields offers a polystyrene melt in high purity that can be further-processed directly, i.e., without a costly and inconvenient degassing step.

This object is achieved as follows. The cooled monomer solution together with initiator solution is optionally heated at 30 to 50° C. and is sprayed or dropletized so as to form small droplets of preferably 0.05 to 1 mm, more preferably 0.1 to 0.4 mm. In the course of their free fall through the spraying tower the monomers are polymerized in the droplets. Preferably there is no addition of solvent and no countercurrent cooling. The droplets therefore heat up to above the melting point of polystyrene. In other words, throughout the period of falling, the droplets are in liquid or melt form. The droplets are captured in a sea of melt. With temperatures at the foot of the tower of above 200° C. the monomers can be reacted almost quantitatively. The result is a melt with a residual monomer content of below 1% and preferably below 0.1% (1000 ppm). The high purity of the melt usually obviates a degassing step or any other purification step, and the polymer melt can be supplied directly to further processing, granulation for example, or the optional degassing step can be performed easily and inexpensively (as strand degassing, for example).

Suitable styrene monomers include all anionically polymerizable vinyl polymers, examples being styrene itself, α-methylstyrene, tert-butylstyrene, vinyltoluene, and divinylbenzene, and mixtures thereof.

Where the styrene polymer is a copolymer, the amount of comonomers is usually 1% to 99%, preferably 5% to 70%, and more preferably 5% to 50% by weight based on styrene.

The process of the invention is preferably used to prepare rubber-free polystyrene (GPPS, general-purpose polystyrene). It is also possible with preference, furthermore, to use the process of the invention to prepare styrene-α-methylstyrene copolymers (PSaMS) having an α-methylstyrene content of, for example, 1% to 50% by weight.

The weight-average molecular weight Mw of the polymer prepared in accordance with the invention is generally 10 000 to 1 000 000, preferably 50 to 500 000, and in particular 100 000 to 400 000 g/mol.

Suitable initiators are alkali metal compounds selected from hydrides, amides, carboxyls, aryls, arylalkyls, and alkyls of the alkali metals, or mixtures thereof. As will be appreciated, a variety of alkali metal compounds can also be used. The preparation of the alkali metal compounds is known and/or the compounds are available commercially.

Particularly suitable are alkali metal organyls. These are alkali metal aryls and alkyls. Alkali metal alkyls are compounds of alkanes, alkenes, and alkynes having 1 to 10 carbon atoms, examples being ethyl-, propyl-, isopropyl-, n-butyl-, sec-butyl-, tert-butyl-, hexamethylenedi-, butadienyl-, and isoprenyl-lithium, -sodium or -potassium, or poly-functional compounds such as 1,4-dilithiobutane or 1,4-dilithio-2-butene. Alkali metal alkyls are especially suitable for preparing the styrene matrix: for example, secbutyllithium can be used with preference for the polymerization of polystyrene.

Examples of suitable alkali metal aryls are phenyllithium and phenylpotassium, and the polyfunctional compound 1,4-dilithiobenzene. Particularly suitable alkali metal arylalkyls are alkali metal compounds of vinyl-substituted aromatics, especially styrylpotassium and styrylsodium M-CH═CH—C₆H₅ with M as K or Na. They are obtainable for example by reacting the corresponding alkali metal hydride with styrene in the presence of an aluminum compound such as TIBA. Also suitable are oligomeric or polymeric compounds such as polystyryl-lithium or -sodium, which is obtainable, for example, by mixing sec-butyllithium and styrene and then adding TIBA. A further possibility is to use diphenylhexyl-lithium or -potassium.

Using adducts of this kind of the initiator with the monomer is also known as preactivation. Preactivation induces a more rapid and better-controlled onset of the reaction after spraying.

Especially suitable alkali metal hydrides are lithium hydride, sodium hydride or potassium hydride.

Other initiators which can be used are reaction products, known as macroinitiators, of the alkali metal or alkaline earth metal compounds with butadiene (e.g., polybutadienyl-lithium), or macroinitiators based on styrene-butadiene block structures.

A further possibility is to use alkali metal alkoxides to modify the reactivity and stability of the anions.

Another option is to use mixtures of different alkali metal compounds and aluminum and/or magnesium organyls in order to stabilize the reactive anionic species for the polymerization at high temperatures. Regarding the amounts of alkali metal compound and aluminum organyl, the following may be stated:

The requisite amount of alkali metal compound is guided, among other things, by the desired molecular weight (molar mass) of the polymer to be prepared; by the nature and amount of the aluminum or magnesium organyl, where used; and by the polymerization temperature. It is usual to use 0.00001 to 1, preferably 0.0001 to 0.1, and more preferably 0.0001 to 0.01 mol % of alkali metal compound, based on the total amount of monomers used.

Aluminum organyls which can be used are, in particular, those of the formula R₃—Al, where the radicals R each independently of one another are hydrogen, halogen, C₁₋₂₀ alkyl, C₆₋₂₀ aryl or C₇₋₂₀ arylalkyl. Preferred aluminum organyls used are aluminum trialkyls.

The alkyl radicals may be the same, e.g., trimethylaluminum (TMA), triethylaluminum (TEA), triisobutylaluminum (TIBA), tri-n-butylaluminum, triisopropylaluminum or tri-n-hexylaluminum, or different, e.g., ethyldiisobutylaluminum. It is also possible to use aluminum dialkyls such as diisobutylaluminum hydride (diBAH).

Aluminum organyls used can also be those formed by partial or complete reaction of alkyl-, arylalkyl- or arylaluminum compounds with water (hydrolysis), alcohols (alcoholysis), amines (aminolysis) or oxygen (oxidation), or those which carry alkoxide, thiolate, amide, imide or phosphite groups. Hydrolysis produces alumoxanes. Examples of suitable alumoxanes include methylalumoxane, isobutylated methylalumoxane, isobutylalumoxane, and tetraisobutyldialumoxane.

Reaction accelerants used for the anionic polymerization may be inert, polar substances such as ethers, preferably cyclic ethers, such as tetrahydrofuran or crown 16 ether. They produce greater dissociation of the aggregated anionic species. Both at the start and during the polymerization, this induces a drastic increase in reaction rate via the fraction of active molecules (active molecules rather than the dormant molecules).

The polymerization is preferably carried out without solvent. However, it may be advisable to add the initiator in solution in a solvent. The choice of solvent also depends on the alkali metal compound used. Alkali metal compound and solvent are preferably selected such that the alkali metal compound dissolves at least partly in the solvent. Moreover, solvents are used which preferably have a boiling point lower than that of the monomer and which through evaporation ensure controlled removal of heat in the droplet. Solvents used are typically C₃ to C₆ alkanes or cycloalkanes such as cyclohexane, methylcyclohexane or hexane or tetrahydrofuran. Mineral oils such as white oil can also be used; they have a low vapor pressure and preferably remain in the polymer.

The finished polystyrene melt can be admixed with customary additives such as stabilizers, flow assistants, flame retardants, blowing agents, fillers, etc., between discharge from the tower and granulation. Additives which have little or no substantial effect on the anionic polymerization can be added to the mixture even prior to spraying. One example of an auxiliary that can be added prior to spraying is white oil.

Monomer and initiator are mixed by means of dynamic or, preferably, static mixing equipment.

The static mixers have the advantage over the dynamic mixers set out in WO 03/103818 that they are less costly and more robust. The two components, styrene and initiator, are preferably mixed at temperatures <10° C., more preferably <0° C., in a static mixer with a minimum flow rate, expressed as Reynolds number (Re>50) with a shear rate >100 1/s and a maximum residence time of <1 s in the mixing section. At smaller flow rates, the shearing stress induced by the flow against the pipe wall is not great enough, and deposits are formed, which grow and lead consequently to fluctuating wear/breakthrough and hence to non-steady-state behavior. Excessively high temperature and long residence time may cause initiation of polymer formation in the mixing section, thereby raising the viscosity of the mixture uncontrollably and adversely affecting droplet formation when spraying or dropletizing.

The design of the static mixer must be suitable for providing adequate homogenization of flows with sharply differing volumes in the correspondingly short time, since after spraying has taken place there is no longer any possibility for concentration balancing between the compartments (droplets), and small differences in concentration lead to dramatic differences in the resulting polymer molecular weight. Embodiments which, though not limiting on the claims of the specification, have nevertheless been found suitable for relatively large volume flows and/or throughputs include what are called split-and-recombine mixers, known to the skilled worker as Kenics- or Sulzer-type mixers and suitable for both large and small throughputs, in the laboratory for example, and what are called interdigital or interlamination mixers (see Hessel et al., AIChE J. 49 (2003) 3, pp. 566-577; Lob et al., Preprints of 11th Europ. Conf. on Mixing, Bamberg, Oct. 14-17, 2003, pp. 253-260).

The mixture is supplied to the spraying tower in a cooled line in order to prevent premature onset of polymerization and the resultant tendency for clogging of the spraying or dropletization unit. The mixture is preferably cooled to temperatures below 10° C. and more preferably below 0° C.

Other possibilities the patent literature mentions to prevent clogging when spraying include
the supplying of one initiator component or of a (co)catalyst via the gas phase (e.g., JP 2003-002905);
the use of externally mixing nozzles, where monomer and initiator are sprayed through separate nozzle apertures and mix only after departing the nozzle (e.g., EP 1424346).

Dispersing in the tower and generation of droplets are generally accomplished by single-fluid or multifluid nozzles, of which coaxial nozzles are an example.

EP-A-1 424 346 and especially EP-A 05/010325.8 describe spray nozzles with which it is possible to produce droplets having the desired size distribution. Alternatively the reactive mixing may take place by means of dropletization, in which case it is possible to utilize not only the “vibrating nozzle” but also a vibration of defined frequency in the kHz range which is imposed on the liquid, for the purpose of forming droplets. A preferred but nonlimiting method of dropletization is described in U.S. Pat. No. 5,269,980.

The droplets formed have an average size of preferably 0.05 to 1 mm and more preferably 0.1 to 0.4 mm.

Dropletization has the advantage over spraying of leading to a homogeneous and narrow particle size distribution. This narrow particle size distribution in turn facilitates controlled polymerization in the spraying tower. With dropletization it is possible in particular to realize an efficient and process-ready polymerization process for polystyrene.

The droplets formed, which initially still have low temperatures (around 0 to 10° C.), meet inert gas as they enter the tower, said gas having a temperature of 80 to 180° C., preferably 100 to 140° C. Because of the large surface area/volume ratio and the small diameter, the droplets attain a temperature close to the gas temperature almost instantaneously. The inert gas can be passed cocurrently or countercurrently with respect to the falling droplets. The cocurrent principle is advantageous for the agglomeration behavior of the droplets and hence for the avoidance of collisions, uncontrolled aggregation, and formation of deposits in the tower. The temperature increase is limited via the evaporation of monomer and auxiliaries. The countercurrent principle leads to a longer average residence time of the droplets in the tower and at the end of the falling section/reaction is able to absorb heat more, but is known from spray drying for its difficulties of formation of deposits. The process is preferably operated in cocurrent with droplets and inert gas stream.

Subsequently, following onset, the polymerization takes place within a few seconds (generally less than 20 and preferably less than 10 seconds) to the end point, with liberation of the heat of polymerization and evaporation of monomer and, where used, solvent. The end point is determined by monomer depletion and, finally, by the dying of the active anions at high temperatures. To stabilize the product it is possible to meter a special terminator into the melt in the outflow from the tower. The termination of the living anions is accomplished by an elimination reaction and/or by protonation during discharge and shaping/granulation, by means of traces of protic substances, e.g., water, alcohols or carbon dioxide.

The temperature profile of the gas phase and of the droplets on their path through the tower is dictated by the feed temperature of the mixture, the temperature of the gas phase on entry, the oil jacket temperature (relatively minor influence, more “active isolation”), the mass flows, the pressure level in the tower, the droplet size, the evaporation of monomer and optional solvent, and the tower geometry. The highly exothermic nature of the polymerization causes the temperature of the droplets to increase rapidly. In the bottom half of the tower the droplets already have temperatures of greater than 110° C., preferably greater than 150° C. It is at the foot of the tower that the highest temperatures occur. The droplets at the foot, which finally are captured in a sea of melt, have a maximum temperature of generally 300° C., preferably 250° C., and more preferably 220° C. If temperatures are too high, discolorations occur and there is premature chain termination. The consequence of the latter is an unwanted increase in residual monomer content.

The temperature in the droplets can be controlled preferably by way of the droplet size. Small droplets are better able to dissipate the heat of reaction via the relatively large surface area, by vaporization. In large droplets there is local overheating. Bursting and deformation of the polymer droplet formed are the consequence. The average droplet size is therefore preferably within the aforementioned range.

The circulation gas taken off from the tower, which comprises typically 5%-30%, preferably 10% to 15%, of the constituents supplied and evaporable by evaporative cooling, is usually passed via a particle separator (a cyclone, for example) and a scrubber. In the particle separator, droplets entrained by the stream of gas are captured, prior to condensation in the scrubber. In the latter the circulation gas is cooled preferably to below 70° C. and more preferably to below 50° C. via a quench circuit and is condensed out in order to “unload” the gas stream and to prevent unwanted (side) reactions, such as polymerization of the condensed monomer.

Additionally, a small amount of a protic high boiler such as stearyl alcohol, for example, is added to the quench fluid, which consists essentially of the condensed monomer, in order to prevent spontaneous anionic polymerization in the aforementioned scrubber.

The circulation gas depleted in monomer and freed from the reactive polymer is recompressed and, after thermal conditioning, is passed again to the tower.

The quenched monomer, freed from the trace of protic high boiler by means of distillation or adsorption, is passed to the monomer feed of the tower. An alternative possibility is to compensate the remaining amount of the protic high boiler by means of a higher initiator feed.

### EXAMPLES

The following compounds were used, for which “purified” means that the compound in question was purified and dried over alumina. All reactions were carried out in the absence of moisture.
Styrene, purified, from BASF
sec-Butyllithium (s-BuLi) as a 12% strength by weight solution in mineral oil, ready-made solution from Chemetall
Winog® 70 mineral oil, a medical white oil from Wintershall

### Example 1

Continuous Preparation of Polystyrene

From reservoir vessels, 570 g/h (5.5 mol/h) of styrene and 1.6 g/h (3.0 mmol/h) of sec-butyllithium in mineral oil (12% strength by weight) were fed to a static mixing unit. From this mixing unit, which was thermally conditioned to 0° C., the reaction solution was transferred via a heat exchanger, thermally conditioned at 40° C., over a very short pathway into a vibrating dropletizer unit. In this unit, droplets measuring about 0.15 mm were formed from the reaction mixture and passed to a thermally conditioned fall tower under atmospheric pressure. The fall tower had a jacketed pipe with a diameter of 80 mm and a height of 2500 mm; the oil jacket temperature was 120° C. Within the fall pipe a gentle nitrogen cocurrent, thermally conditioned at 100° C., was established. At the base of the tower the melt droplets were collected in a sea of melt at 220° C.

According to GPC the melt contained polystyrene having a weight-average molar mass of 220 000 g/mol. HPLC analysis showed a residual styrene content of 300 ppm.

By means of the inventive spray polymerization it was possible to obtain polystyrene with a high molar mass and a reduced residual monomer content in relation to comparable industrial products.

1. A process for continuously preparing styrene polymer by anionic spray polymerization, comprising
i) mixing styrene and an initiator solution in a dynamic or static mixer and then spraying or dropletizing the mixture in an inert, thermally conditioned gas space,
ii) passing the resultant droplets from the liquid monomer state to the melted polymer state during their free fall in the spraying tower, and
iii) collecting the melt droplets as a melt at the foot of the tower, the melt having a monomer content of below 1% and discharging the melt.

2. The process according to claim 1, wherein the droplets in the bottom half of the tower have a temperature of 110 to 250° C.

3. The process according to claim 1, wherein the melt at the foot of the tower has a temperature of 200 to 250° C.

4. The process according to claim 1, wherein the initiator is an alkali metal organyl or alkaline earth metal organyl or an alkali metal hydride or alkaline earth metal hydride.

5. The process according to claim 4, wherein the initiator is s-butyllithium.

6. The process according to claim 4, wherein further to the initiator an ether is used as a reaction accelerant.

7. The process according to claim 6, wherein the reaction accelerant is tetrahydrofuran (THF).

8. The process according to claim 6, wherein the reaction accelerant is not sprayed or dropletized with monomer and initiator but instead is supplied to the droplets via the gas phase.

9. The process according to claim 4, wherein further to the initiator an anion stabilizer is used.

10. The process according to claim 9, wherein the anion stabilizer used is an aluminum organyl.

11. The process according to claim 1, wherein the droplets formed by spray polymerization have an average diameter of 0.1 to 0.4 mm.

12. The process according to claim 1, wherein initiator and styrene are mixed in a static mixer.

13. The process according to claim 12, wherein initiator and styrene are mixed in a static mixer of a split-and-recombine type.

14. The process according to claim 12, wherein initiator and styrene are mixed in a static mixer of a interlamellation type.

15. The process according to claim 1, wherein the initiator is dissolved in a solvent having a boiling point lower than that of styrene.

16. The process according to claim 1, wherein the initiator is dissolved in a solvent having a boiling point higher than that of styrene and is largely discharged with the polymer formed.

17. The process according to claim 1, wherein gas and droplets are passed cocurrently through the reaction space.

18. The process according to claim 1, wherein the droplets are generated by spraying with one or more nozzles.

19. The process according to claim 1, wherein the droplets are generated by dropletization.

20. The process according to claim 1, wherein the droplets collected in a melt at the foot of the tower have a monomer content of below 0.1%.
